(19) United States
(12) Patent Application Publication
(10) Pub. No.: US 2003/0233958 A1
(43) Pub. Date: Dec. 25, 2003

(54) Vehicle carousel

(76) Inventor: Edward D'Alessandro JR., Mendham, NJ (US)

Correspondence Address: KENYON & KENYON, ONE BROADWAY, NEW YORK, NY, 10004, US

(21) Appl. No.: 10/176,429

(22) Filed: Jun. 20, 2002

(51) Int. Cl. B60S 13/02

(52) U.S. Cl. 104/44

(57) ABSTRACT

The invention provides a vehicular carousel comprising a base structure defining an interior volume and a plate cutout, a support member arranged in the interior volume, a series of rolling members supported by the support member, and a platform supported in the plate cutout by the series of rolling members, wherein the vehicular carousel is configured to support and rotate a vehicle, such as a motorcycle.

### FIELD OF THE INVENTION

The present invention relates to parking of motor vehicles. More specifically, the present invention relates to a structure to park a motor vehicle, such as a motorcycle, where the vehicle may be rotated at the discretion of the vehicle operator.

### BACKGROUND INFORMATION

Motor vehicles, particularly motorcycles, are increasingly common forms of transportation. The common motorcycle has many advantages over other forms of transportation. Better fuel economy, less capital cost and relative freedom of the rider often attracts riders of varying ages and skill levels. As a result, a large demand for motorcycles exists for the general public.

Manufacturers of motorcycles have responded to increased demand by producing many models with varying physical features. While some motorcycles remain relatively small and compact, others may weigh in excess of 1000 pounds.

As motorcycle enthusiasts know, several key aspects of the motorcycle hobby have detracted from the overall motorcycle riding experience. Parking the motorcycle is especially challenging as the relative size of the motorcycle and reduction in speed requires the rider to maintain a careful balance to avoid tipping over. If a rider shifts balance too much, the center of gravity of the motorcycle, coupled with the weight, can result in the rider dropping the motorcycle on its side damaging farings, exhaust pipes, handle bars, and other equipment. The result of a drop can be financially expensive and repairs are often needed.

Therefore, there is a need to allow a motor vehicle, especially a motorcycle, to be easily parked such that upon restart, the rider may easily remove the motorcycle from the parking spot.

There is also a need to allow rotation of the motor vehicle through the manual actions of a single person.

There is a further need to rotate a motor vehicle in both existing structures and in new construction.

There is still further need to have a motor vehicle be rotated at several different locations in a common structure.

### SUMMARY OF THE INVENTION

It is an object of the present invention to provide a device which will allow a vehicle operator to rotate a vehicle after parking such that the vehicle may be positioned in a 180° degree rotation from an original parking position.

It is also an object of the present invention to allow rotation to occur through manual pushing of a single person.

It is a further object of the present invention to allow the device to be installed in an existing garage or to be installed in a new garage.

It is a still further object of the present invention to allow the device to be portable such that it may be moved by a user.

These and other objects of the invention, which will become apparent from the following detailed description, are achieved as described. The invention provides a vehicular carousel comprising a base structure defining an interior volume and a plate cutout, a support member arranged in the interior volume, a series of rolling members supported by the support member, and a platform supported in the plate cutout by the series of rolling members, wherein the vehicular carousel is configured to support and rotate a vehicle.

### BRIEF DESCRIPTION OF THE DRAWINGS

FIG. 1 is a top perspective view of a vehicle carousel according to the present invention.

FIG. 2 is a side view of the support member of the vehicle carousel of FIG. 1.

FIG. 3 is a side view of the leading edge of FIG. 1.

FIG. 4 is a side view of handle of FIG. 1.

FIG. 5 is a bottom view of the platform of FIG. 1.

### DETAILED DESCRIPTION OF THE INVENTION

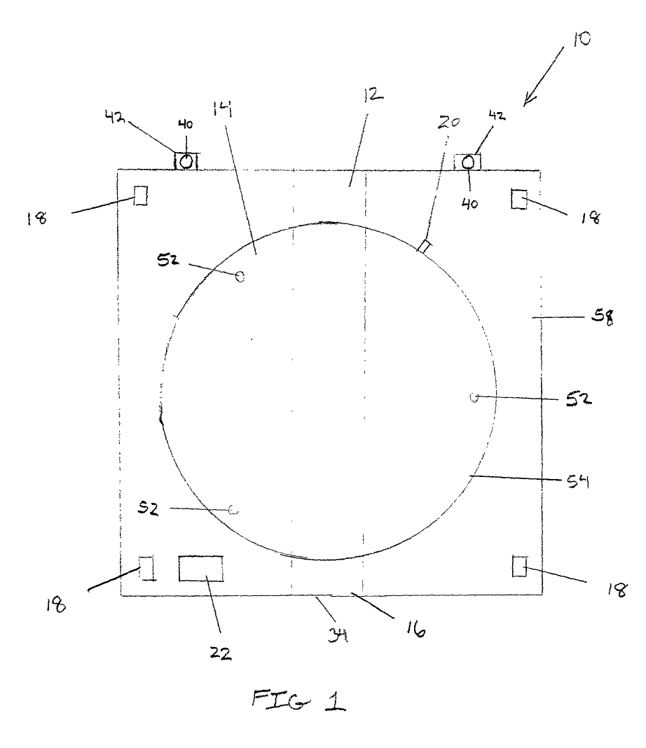

Referring to FIG. 1, a vehicular carousel 10 in conformance with the invention is shown. The vehicular carousel 10 is comprised of a base structure 12, a rotating platform 14, a support member 24 and a series of rolling members 26.

The base structure 12 is configured to support a vehicle and to allow rotation of the platform 14 once the vehicle is fully positioned upon the platform 14. The base structure 12 may be made of metal with an appropriate thickness to support anticipated vehicle weights. The material may be, for example, checker plate with a slip-limiting surface to allow traction on the structure 12 for both users and vehicles. The base structure 12, in the example shown, is configured such that bending from supported loads is limited. The base structure 12 is configured to define an interior volume 58 and define a plate cut out 54. The plate cut out 54 is configured with a round geometry to limit potential pinch-points for a moving platform 14, however, other configurations are possible. The structure 12 is constructed of non-corrosive material such as stainless steel to provide a long lasting unblemished appearance. As will become apparent to those skilled in the art, other materials such as A36 carbon steel may also be used facilitating easy fabrication. The structure 12 may be fabricated from plates, for example, welded together.

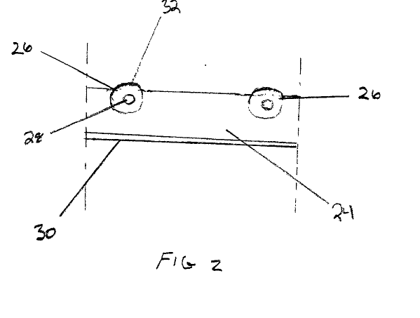

A rotating platform 14 is located in the plate cut out 54 of the base structure 12. The platform is supported by the support member 24 and rolling members, see FIG. 2, (described later). Again referring to FIG. 1, the rotating platform 14 may be configured from a metal material similar to the base structure 12. The platform 14 may be configured with a slip-resistant surface to allow superior traction of vehicles and riders on the structure 12. In the example, the embodiment platform 14 is configured with lift points 52 to allow the platform 14 to be installed and/or removed from the base structure 12 in an efficient manner. In the configuration illustrated three lift points 52 are located through the platform 14. As will be recognized by those skilled in the art, varying numbers of lift points 52 may be used to facilitate removal of the platform 14.

A stripe 16 may be located on the base structure 12 and the platform 14 to allow visual identification of the position of the platform 14 by a user. The stripe 14 may be painted on the exterior of the base structure 12 and the platform 14. The stripe 14 may also be produced by metal working techniques such that the stripe 14 is a chrome surface with the remainder of the exterior of the base structure 12 and the platform 14 being a non-shiny/chrome surface. The stripe 14 may be applied such that the stripe 14 does not affect the slip resistant capabilities of the base structure 12 and the platform 14.

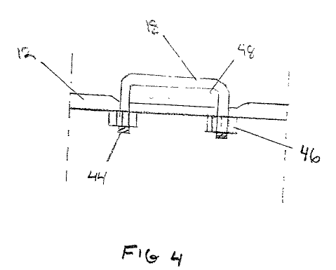

A handle 18 may be placed in conjunction with the base structure 12 to allow the base structure 12 to be lifted and moved if required. Differing configurations of handles 18 may be used, and as such the example embodiment shown should not be considered limiting. In the example embodiment shown, referring to FIG. 4, a handle 18 may be configured as a “U” shaped structure with threaded ends 44 penetrating the base structure 12. The base structure 12 may be formed such that the handle 18 when in a retracted state is flush with the surface of the base structure 12. The handle 18 may be configured with substantial length such that in an extended position, the handle 18 allows an offset 48 sufficient to allow access for lifting the base structure 12. Resistence to pull out of the handle 18 may be accomplished through use of nuts 46 which bind on the underside of the structure 12. The threaded end 44 of the handle 18 and the nuts 46 may have corresponding threaded complimentary connections allowing transfer of load from the handle 18 through the nut 46 to the structure 12. The threads per inch of the nut 46 and the threaded end 44 connection may be chosen to allow for sufficient load carrying capability with a factor of safety, for example, of 4.

Referring to FIG. 1, an interlock 20 is configured to allow a user to engage and disengage the platform 14 rotation. In a disengaged state, the interlock 20 allows movement of the platform 14 in a circular geometry. In an engaged state, the interlock 20 prevents movement of the platform 14. The interlock 20 may be configured such that the interlock 20 is flush with the exterior surface of the structure 12 and the platform 14 or may protrude from the exterior surface of the structure 12 and the platform 14. In the example configuration, the interlock 20 is configured as a foot pedal with a “step on release” mechanism, allowing rotation of the platform 14. The interlock 20 may be painted to allow easy identification of the interlock position. The interlock 20 may also be configured, if arranged as a protruding mechanism, such that the interlock 20 will not extend sufficiently to damage an undercarriage of a vehicle if driven over the interlock 20.

A label area 22 may be configured on the base structure 12. The label area 22 allows attachment of labels and/or warning information to the base structure 12 alerting users and others to operational use restrictions. The label area 22 may be brightly colored and contain wording or pictograms for instructional conveyance. The label area 22 may be formed as a recessed area, limiting contact upon the labels, consequently extending service life.

Sheer pins 40 may be installed through tabs 42 or similar structural members to allow the vehicle carousel 10 to take horizontal impact loads when a vehicle is driven upon the carousel 10. The sheer pins 40 may be constructed from high strength metal or similar material to prevent sliding of the carousel 10. The pins 40 may be removable to allow the carousel 10 to be moved at the discretion of the user.

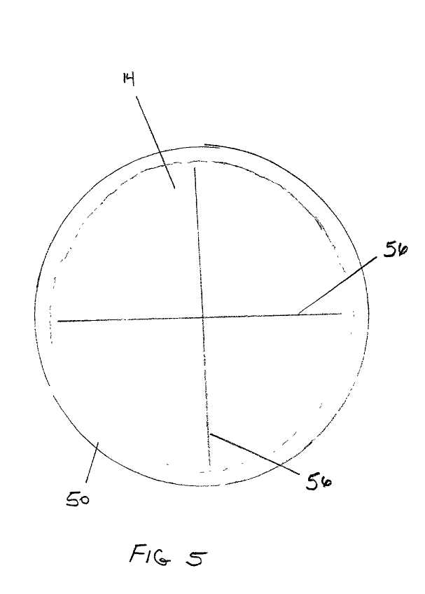

Referring to FIG. 5, the underside of the platform 14 is shown. The underside of the platform 14 may be constructed with a mating surface 50 which allows the platform 14 to ride upon the rolling members 26. The mating surface 50 may be configured as a circular shaped channel with an exterior diameter chosen to limit drift of the platform 14 under rotating conditions. The platform 14 may also be configured with trusses 56 which provide structural rigidity to the platform 14. The trusses 56 may be attached to the platform 14 through a welded or bolted connection. The trusses 56 may be configured such that the ends of the trusses 56 do not inhibit the rotation of the platform 14.

Referring to FIG. 2, a support member 24 with attached rolling members 26 is placed in the interior volume of the base structure 12. The support member 24 allows for transfer of a vehicle load from the vehicle wheels through the platform 14 to the rolling member 26, the support member 24, ultimately transferring the weight to the floor through a floor contact surface 30. The support member 24 may be configured as a structural member, such as a channel or a beam with coping to allow transfer of the forces. The rolling members 26 may be in the form of wheels or other suitable arrangements. The member 26 may be constructed from rubber, nylon or other material for limiting slip and for compressive capacity. The rolling member 26 is constructed such that the wheel contact point 32 has an elevation above the support member 24 to allow rolling to occur. The center of the rolling member 26 may be configured with a bearing 28 to allow relative rotation. Any bearing 28 used for rotational purposes may be used including for example, ball, roller and tapered roller bearings. The bearings are self lubricating items, for example, thus limiting maintenance.

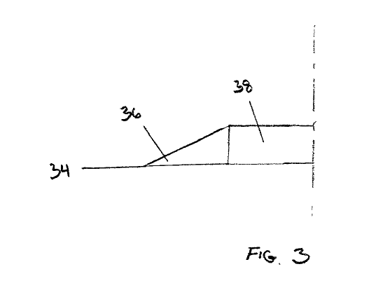

Referring to FIG. 3, a side view of a leading edge 34 of the base structure 12 is shown. A leading edge 34 of the base structure 12 allows a user in a vehicle to drive upon the vehicle carousel 10 without difficulty due to the angle 36 of the leading edge 34. As will be apparent to those skilled in the art, the angle 36 may be modified to allow for an abrupt or gradual change in elevation from a floor resting position to the top of the base structure 12. The leading edge 34 also may be eliminated in a configuration where the base structure 12 is directly placed in a floor slab eliminating a need for a change in elevation. In an embodiment where a leading edge 34 is necessary, the leading edge 34 may be reinforced to allow impact loading to occur without damage to the carousel 10. An exterior support 38 may be configured around the perimeter of the base structure 12 to add structural strength. The exterior support 38 may be constituted by a channel, beam or other structural member to allow load transfer. Typical loading may include loads from a motorcycle, a car or a sport utility vehicle.

Operationally, the user, in the present example a motorcycle rider, visually identifies the stripe 16 of the vehicle carousel 10 and its relative position. After visually identifying the stripe 16 and its position in an unrotated position, the rider rides the motorcycle up the leading edge 34 of the base structure 12 and onto the platform 14. The user then shuts off the engine of the motorcycle and engages a stand on the motorcycle. When the rider desires to ride the motorcycle once again, the rider may disengage the interlock 20 to allow rotation of the platform 14 to a 180° position from the originally parked position. The rider may then engage the interlock 20 to stop possible rotation of the platform 14. The rider then starts the engine of the motorcycle and, with the motorcycle now headed in an opposite direction relative to the original starting position, drives the motorcycle off the carousel 10.

The current invention allows a user to rotate a vehicle, such as a motorcycle without requiring the user to “back out” of a parking spot. In a “built in the floor slab” embodiment, the carousel 10 allows a rotation of the vehicle without excessive vertical space taken up by the carousel 10. Loadings normally present in the garage environment may be directly imparted onto the carousel 10 without detrimental effect. The compact size of the invention, in either a “built in” configuration or a movable configuration, allows rotation functionality without severely impacting available garage floor space. In the case of motorcycle riders, especially novice riders, the carousel 10 allows for rotation of the motorcycle without the rider having to precariously support the weight of the motorcycle. Thus, the carousel 10 prevents human error and both the physical and financial consequences of dropping the motorcycle. In a mobile configuration, the carousel 10 may be quickly installed of a person of limited mechanical skill to provide the needed functionality. The carousel 10 may be removed easily as well, allowing garage floor space to be used for other purposes if desired.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than a restrictive sense.

What is claimed is:

1. A vehicular carousel comprising:
a base structure defining an interior volume and a plate cutout;
a support member arranged in the interior volume;
a series of rolling members supported by the support member; and
a platform supported in the plate cutout by the series of rolling members, wherein the vehicular carousel is configured to support and rotate a vehicle.

2. The vehicular carousel according to claim 1, wherein the series of rolling members is comprised of wheels with internal bearings.

3. The vehicular carousel according to claim 2, wherein the internal bearings are roller bearings.

4. The vehicular carousel according to claim 1, wherein the base structure and the rotating platform are configured with a slip limiting surface.

5. The vehicular carousel according to claim 1, wherein the base structure is configured with flush storing handles.

6. The vehicular carousel according to claim 1, further comprising:
an interlock configured to allow engagement and disengagement of the platform.

7. The vehicular carousel according to claim 6, wherein the interlock is configured as a foot pedal.

8. The vehicular carousel according to claim 7, wherein the interlock is flush with both the exterior surfaces of the platform and the base structure.

9. The vehicular carousel according to claim 1, further comprising:
a stripe configured to allow visual position identification by a user.

10. The vehicular carousel according to claim 1, further comprising:
shear pins, the shear pins adapted to be inserted into the base structure to transfer shear loads.

11. The vehicular carousel according to claim 1, wherein the base structure is configured with a label area.

12. The vehicular carousel according to claim 1, wherein the platform is configured with at least three lift points.

13. The vehicular carousel according to claim 1, wherein the platform is configured with at least one bottom truss.

14. The vehicular carousel according to claim 13, wherein the bottom truss is attached to the platform by welding.

15. The vehicular carousel according to claim 1, wherein the base structure and the platform are made from metal.

16. The vehicular carousel according to claim 15, wherein the metal is non-corrosive.
